(19) United States
(12) Patent Application Publication
(10) Pub. No.: US 2007/0170858 A1
(43) Pub. Date: Jul. 26, 2007

(54) BACKLIGHT ASSEMBLY AND DISPLAY DEVICE HAVING THE SAME

(75) Inventors: Don-Chan CHO, Seongnam-si (KR); Hae-Il PARK, Seoul (KR); Jin-Seob BYUN, Seoul (KR); Sang-Yu LEE, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/536,950

(22) Filed: Sep. 29, 2006

(30) Foreign Application Priority Data
Jan. 23, 2006 (KR) 1020060006668

(51) Int. Cl. H01J 1/62

(52) U.S. Cl. 313/512

(57) ABSTRACT

A backlight assembly includes a flat fluorescent lamp and a bottom chassis. The flat fluorescent lamp includes a first substrate, a second substrate and an external electrode. The second substrate is combined with the first substrate to form a plurality of discharge spaces. The external electrode crosses the discharge spaces. The bottom chassis receives the flat fluorescent lamp and includes a protruded portion spaced apart from the flat fluorescent lamp by a distance that is different from a distance between a remaining portion of the bottom chassis and the flat fluorescent lamp.

### BACKLIGHT ASSEMBLY AND DISPLAY DEVICE HAVING THE SAME

The present application claims priority to Korean Patent Application No. 2006-06668, filed on Jan. 23, 2006, and all the benefits accruing therefrom under 35 U.S.C. §119, the disclosure of which is hereby incorporated herein by reference in its entirety.

### BACKGROUND OF THE INVENTION

1. Field of the Invention

The present invention relates to a backlight assembly and a display device having the backlight assembly. More particularly, the present invention relates to a backlight assembly capable of improving temperature uniformity to improve light emission characteristics and a display device having the backlight assembly.

2. Description of the Related Art

A liquid crystal display (LCD) device includes an LCD panel that is a non-emissive type display device and does not generate light. Thus, the LCD device requires a light source supplying the LCD panel with the light.

Screen sizes of the LCD device have increased, and a flat fluorescent lamp (FFL) has been developed to decrease manufacturing cost and to simplify the manufacturing process. The FFL includes a plurality of discharge spaces to generate the light in a large amount an/or area, and to increase luminance uniformity of the light generated by the FFL. External electrodes are formed on both end portions of the FFL to drive the FFL and the external electrodes cross the discharge spaces.

In operation, the FFL generates heat so that a convection of air is formed in the discharge spaces, thereby deteriorating temperature uniformity of the FFL. Thus, mercury (Hg) in the discharge spaces drifts in the discharge spaces through throughholes and conduits of the FFL. When the FFL is operated for a relatively long time, a density of mercury in the discharge spaces at an upper portion and a lower portion of the FFL is greater than a density of mercury in the discharge spaces at a central portion of the FFL. Luminance deterioration is caused by the density difference between the discharge spaces at the upper and/or lower portion and the central portion of the FFL. That is, luminance of the central portion is smaller than the luminance of the upper or lower portion.

### BRIEF SUMMARY OF THE INVENTION

An exemplary embodiment provides a backlight assembly capable of improving temperature uniformity to improve light emission characteristics.

An exemplary embodiment also provides a display device having the above-mentioned backlight assembly.

An exemplary embodiment of backlight assembly includes a flat fluorescent lamp and a bottom chassis. The flat fluorescent lamp includes a first substrate, a second substrate and an external electrode. The second substrate is combined with the first substrate to form a plurality of discharge spaces. The external electrode crosses the discharge spaces. The bottom chassis receives the flat fluorescent lamp, and includes a protruded portion spaced apart from the flat fluorescent lamp by a distance that is different from a distance between a remaining portion of the bottom chassis and the flat fluorescent lamp.

In an exemplary embodiment, the protruded portion may include a first external protrusion protruded toward an exterior of the bottom chassis so that a distance between the first external protrusion and the flat fluorescent lamp is greater than the distance between the remaining portion of the bottom chassis and the flat fluorescent lamp. The first external protrusion may correspond to a lower portion of the flat fluorescent lamp when the flat fluorescent lamp is aligned substantially vertical. The first external protrusion may correspond to five discharge spaces corresponding to the lower portion of the flat fluorescent lamp. The distance between the first external protrusion and the flat fluorescent lamp may be increased as a distance from a lower portion of the flat fluorescent lamp is decreased.

In an exemplary embodiment, the protruded portion may further include a second external protrusion corresponding to an upper portion of the flat fluorescent lamp. The second external protrusion may correspond to uppermost discharge spaces on the upper portion of the flat fluorescent lamp. The distance between the second external protrusion and the flat fluorescent lamp may be increased as a distance from an upper portion of the flat fluorescent lamp is decreased.

In an exemplary embodiment, the protruded portion may include an internal protruded portion protruded toward an interior of the bottom chassis so that a distance between the internal protrusion and the flat fluorescent lamp is smaller than the distance between the remaining portion of the bottom chassis and the flat fluorescent lamp. The internal protruded portion may correspond to a central portion of the flat fluorescent lamp. The internal protruded portion may correspond to a power supply printed circuit board disposed on a rear surface of the bottom chassis.

In an exemplary embodiment, the protruded portion may include an external protruded portion and an internal protruded portion. The external protruded portion is protruded toward an exterior to the bottom chassis so that a distance between the external protruded portion and the flat fluorescent lamp is greater than the distance between the remaining portion of the bottom chassis and the flat fluorescent lamp. The internal protruded portion is protruded toward an interior to the bottom chassis so that a distance between the internal protruded portion and the flat fluorescent lamp is smaller than the distance between the remaining portion of the bottom chassis and the flat fluorescent lamp. The internal protruded portion may correspond to a power supply printed circuit board disposed on a rear surface of the bottom chassis. The external protruded portion may include a first external protrusion corresponding to a lower portion of the flat fluorescent lamp. The external protruded portion may include a second external protrusion corresponding to an upper portion of the flat fluorescent lamp.

In an exemplary embodiment, the flat fluorescent lamp may include a lamp body and an external electrode. The lamp body may include the first substrate and the second substrate combined with the first substrate to form the discharge spaces. The external electrode is disposed on the lamp body and crosses the discharge spaces. The second substrate may include a plurality of discharge portions, a plurality of non-discharge portions and a sealing portion. The discharge portions may be spaced apart from the first substrate to form the discharge spaces. The non-discharge portions may make contact with the first substrate between adjacent discharge portions. The sealing portion may be on a peripheral portion that surrounds the discharge portions and the non-discharge portions. The first substrate may be combined with the second substrate through the sealing portion.

In an exemplary embodiment, he backlight assembly may further include a buffer member interposed between the flat fluorescent lamp and the bottom chassis so that the flat fluorescent lamp is spaced apart from the bottom chassis.

Another exemplary embodiment of a display device includes a backlight assembly and a display unit. The backlight assembly generates light and includes a flat fluorescent lamp and a bottom chassis. The flat fluorescent lamp includes a first substrate, a second substrate combined with the first substrate to form a plurality of discharge spaces and an external electrode crossing the discharge spaces. The bottom chassis receives the flat fluorescent lamp, and includes an external protruded portion spaced apart from the flat fluorescent lamp by a distance that is greater than a distance between a remaining portion of the bottom chassis and the flat fluorescent lamp. The display unit displays images based on the light generated from the backlight assembly.

In an exemplary embodiment, a temperature uniformity of the flat fluorescent lamp is increased and drifting of mercury caused by a temperature difference is decreased, thereby improving light emission characteristics of the flat fluorescent lamp.

### BRIEF DESCRIPTION OF THE DRAWINGS

The above and other advantages of the present invention will become more apparent by describing in detail example embodiments thereof with reference to the accompanying drawings, in which:

FIG. 1 is an exploded perspective view illustrating an exemplary embodiment of a backlight assembly in accordance with the present invention;

FIG. 2 is a cross-sectional view illustrating the backlight assembly shown in FIG. 1;

FIG. 3 is a graph illustrating an exemplary embodiment of a temperature distribution of a flat fluorescent lamp having a bottom chassis including a substantially flat bottom plate in accordance with the present invention;

FIG. 4 is a cross-sectional view illustrating another exemplary embodiment of a bottom chassis having a first external protruded portion in accordance with the present invention;

FIG. 5 is a cross-sectional view illustrating another exemplary embodiment of a bottom chassis in accordance with the present invention;

FIG. 6 is a cross-sectional view illustrating another exemplary embodiment of a bottom chassis including first and second external protruded portions in accordance with the present invention;

FIG. 7 is a plan view illustrating an exemplary embodiment of a rear surface of a bottom chassis in accordance with the present invention;

FIG. 8 is a cross-sectional view taken along line I-I′ shown in FIG. 7;

FIG. 9 is a cross-sectional view illustrating another exemplary embodiment of a bottom chassis in accordance with the present invention;

FIG. 10 is a perspective view illustrating an exemplary embodiment of a flat fluorescent lamp shown in FIG. 1;

FIG. 11 is a cross-sectional view taken along line II-II′ shown in FIG. 10; and

FIG. 12 is an exploded perspective view illustrating an exemplary embodiment of a display device in accordance with the present invention.

### DEATAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

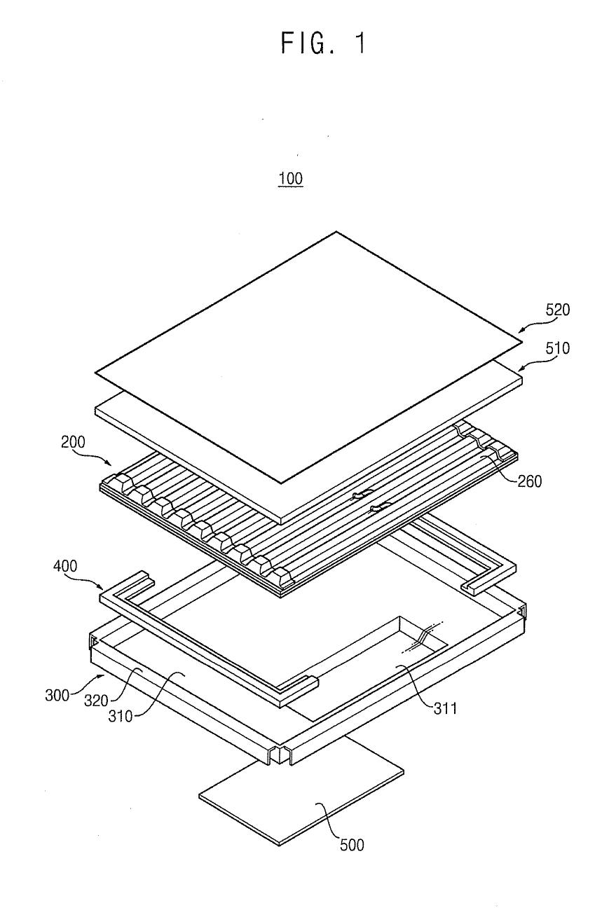

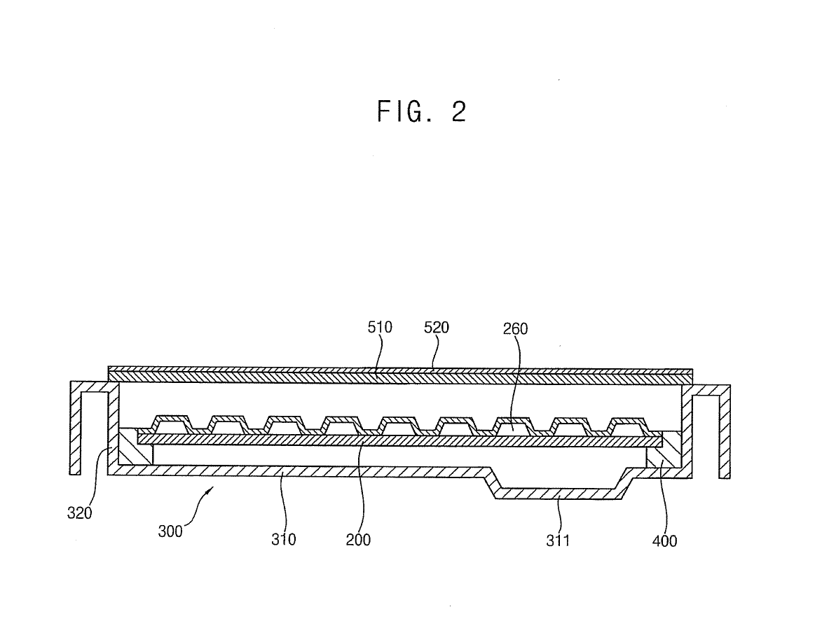

FIG. 1 is an exploded perspective view illustrating an exemplary embodiment of a backlight assembly in accordance with the present invention. FIG. 2 is a cross-sectional view illustrating the backlight assembly shown in FIG. 1.

Referring to FIGS. 1 and 2, the backlight assembly 100 includes light source 200, such as a flat fluorescent lamp, and a bottom chassis 300.

The flat fluorescent lamp 200 includes a plurality of discharge spaces 260 that are spaced apart from each other and generate light. The flat fluorescent lamp 200 may have a substantially quadrangular shape when viewed on a plane to generate a surface shaped light.

The flat fluorescent lamp 200 generates plasma discharge in the discharge spaces 260 based on electric power from a power supply printed circuit board 500. Ultraviolet (UV) light is generated based on the plasma discharge and the ultraviolet light is changed into visible light so that the flat fluorescent lamp 200 emits the light. An internal space of the flat fluorescent lamp 200 is divided into the discharge spaces 260 to increase luminance uniformity and a size of light emission area. In one exemplary embodiment, the flat typed fluorescent lamp 200 may include twenty-eight discharge spaces 260.

The bottom chassis 300 includes a bottom plate 310 and a sidewall 320 that is protruded from sides of the bottom plate 310 to form a receiving space. In exemplary embodiments, the bottom chassis 300 includes a strong metal that is resistant to deformation and a high thermal conductivity.

The bottom chassis 300 includes a protruded portion that is spaced apart from a bottom surface of the flat fluorescent lamp 200. The protruded portion and a remaining portion of the bottom chassis 300 (other than the protruded portion) are spaced apart from the flat fluorescent lamp 200 at different distances. The protruded portion may have various shapes based on a temperature distribution of the flat fluorescent lamp 200.

When the flat fluorescent lamp 200 aligned in substantially a vertical direction that may be substantially the same as a gravitational (or normal) direction is operated during a relatively long time, temperature of a portion of the flat fluorescent lamp 200 is changed based on a location of the portion on the flat fluorescent lamp 200.

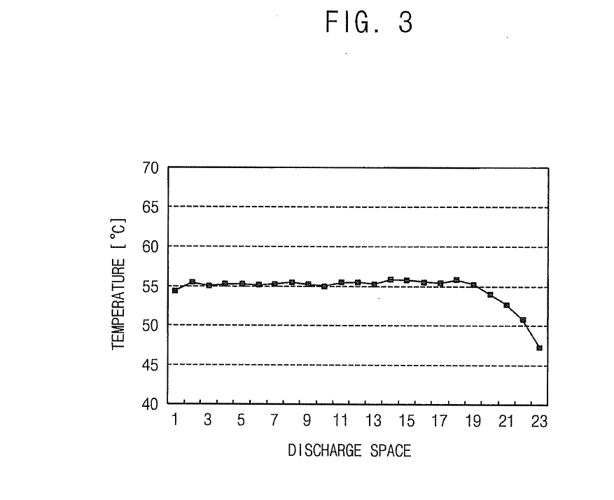

FIG. 3 is a graph illustrating an exemplary embodiment of a temperature distribution of a flat fluorescent lamp having a bottom chassis including a substantially flat bottom plate. The flat fluorescent lamp of FIG. 3 is essentially the same as in FIGS. 1 and 2. Thus, the same reference numerals will be used to refer to the same or like parts as those described in FIGS. 1 and 2 and any further explanation concerning the above elements will be omitted.

Referring to FIG. 3, a bottom plate 310 of a bottom chassis 300 has a substantially flat shape. When a lower surface of a flat fluorescent lamp 200 (shown in FIGS. 1 and 2) is spaced apart from the bottom plate 310 of the bottom chassis 300 by a constant or uniform distance and the flat fluorescent lamp 200 aligned in substantially a vertical direction, a temperature of five lowermost discharge spaces 260 (numbered 19-23 in FIG. 3) corresponding to a lower portion of the flat fluorescent lamp 200 is lower than a temperature of the remaining discharge spaces. In particular, an outmost (or lowest) discharge space of the five lowermost discharge spaces has the lowest temperature. In addition, an uppermost discharge space (numbered 1 in FIG. 3) of the remaining discharge spaces has a relatively lower temperature than a portion of the discharge spaces on a, inner or central portion of the flat fluorescent lamp 200.

In FIGS. 1 and 2, in order to increase the temperature of discharge spaces 260 that are on the lower portion of the flat fluorescent lamp 200 having lower temperatures, the bottom chassis 300 includes a first external protruded portion 311. The first external protruded portion 311 is protruded toward an exterior of the bottom chassis 300 such that a distance between the flat fluorescent lamp 200 and the bottom chassis 300 is increased. The lower surface of the first external protruded portion 311 is substantially parallel to the bottom plate 310 of the bottom chassis 300. Side parts of the first external protruded portion 311 are inclined down from the bottom plate 310 towards the lower surface of the first external protruded portion 311. The distance between the flat fluorescent lamp 200 and the lower surface of the first external protruded portion 311 is substantially uniform as illustrated in FIG. 2.

When the distance between the flat fluorescent lamp 200 and the bottom chassis 300 is increased, the temperature of the flat fluorescent lamp 200 corresponding to an area of the first external protruded portion 311 is increased by a heat insulating effect. In exemplary embodiments, the distance between the flat fluorescent lamp 200 and the first external protruded portion 311 is adjusted such that the temperature of the discharge spaces 260 at the lower portion of the flat fluorescent lamp 200 previously having a lower temperature will have substantially the same temperature as the temperature of the central portion of the flat fluorescent lamp 200.

In FIG. 3, the discharge spaces on the lower portion of the flat fluorescent lamp 200 have the lower temperature than the central portion of the flat fluorescent lamp 200. Therefore, in FIGS. 1 and 2, the first external protruded portion 311 corresponds to those discharge spaces 260 on the lower portion of the flat fluorescent lamp 200.

Referring again to FIGS. 1 and 2, the backlight assembly 100 may further include a buffer member 400 that is interposed between the flat fluorescent lamp 200 and the bottom chassis 300. The flat fluorescent lamp 200 is spaced apart from the bottom chassis 300 by the buffer member 400 so that the flat fluorescent lamp 200 is electrically insulated from the bottom chassis 300. In exemplary embodiments, the bottom chassis 300 may include a metal. The buffer member 400 may include an elastic material to absorb an externally provided impact to protect the flat fluorescent lamp 200. In one exemplary embodiment, the buffer member 400 may include silicone.

The backlight assembly 100 may further include the power supply printed circuit board 500 that is disposed on a rear surface of the bottom chassis 300. The power supply printed circuit board 500 may include an inverting part that generates an electric power to drive the flat fluorescent lamp 200. In addition, the power supply printed circuit board 500 may further include a power supplying part that generates a driving voltage to drive a display unit (not shown). The display unit displays images.

The backlight assembly 100 may further include a diffusion plate 510 that is disposed on the flat fluorescent lamp 200. The diffusion plate 510 diffuses the light generated from the flat fluorescent lamp 200 to increase luminance uniformity. The diffusion plate 510 may have a substantially plate shape having a predetermined thickness. The diffusion plate 510 may be spaced apart from the flat fluorescent lamp 200 by a constant or uniform distance. In one exemplary embodiment, the diffusion plate 510 includes polymethylmethacrylate (PMMA) and/or diffusing agent for diffusing the light.

The backlight assembly 100 may further include an optical sheet 520 that is on the diffusion plate 510. The optical sheet 520 may include any of a number of individual optical members. In one exemplary embodiment, the optical sheet 520 may include a brightness enhancement sheet that guides the light having passed through the diffusion plate 510 to increase a luminance when viewed on the plane. In addition, the optical sheet 520 may further include a diffusion sheet that diffuses the light having passed through the brightness enhancement sheet to increase the luminance uniformity. In alternative embodiments, the backlight assembly 100 may further include additional sheets. A portion and/or a specific optical member described above of the optical sheet 520 may be omitted.

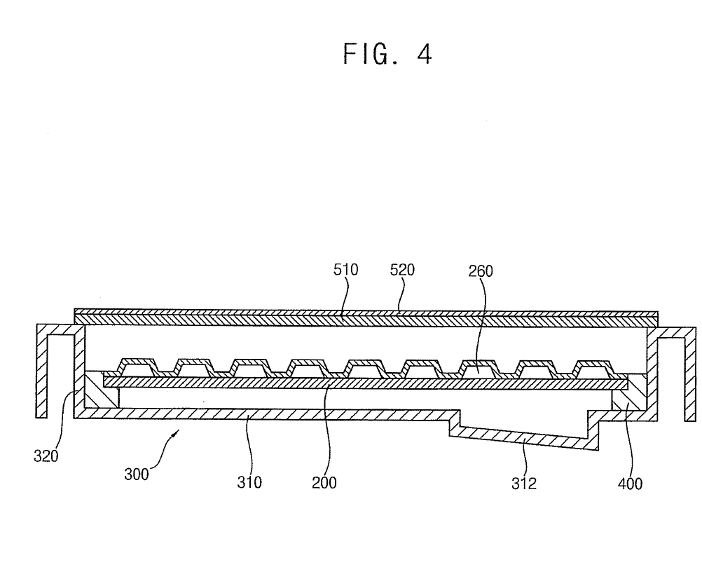

FIG. 4 is a cross-sectional view illustrating another exemplary embodiment of a bottom chassis including a first external protruded portion in accordance with the present invention. A backlight assembly of FIG. 4 is same as in FIGS. 1 and 2 except the first external protruded portion. Thus, the same reference numerals will be used to refer to the same or like parts as those described in FIGS. 1 and 2 and any further explanation concerning the above elements will be omitted.

Referring to FIG. 4, the first external protruded portion 312 is inclined with respect to a lower surface of the flat fluorescent lamp 200. In particular, a distance between the first external protruded portion 312 and the lower surface of the flat fluorescent lamp 200 is increased as a distance from a lower portion of the flat fluorescent lamp 200 is decreased, or closer to the lower portion of the flat fluorescent lamp 200.

In FIG. 3, where the bottom chassis has a substantially flat bottom plate, discharge spaces on a lower portion of a flat fluorescent lamp have a lower temperature than discharge spaces on a central portion of the flat fluorescent lamp. In addition, the temperature of the discharge spaces is decreased as a distance from a lower portion of the flat fluorescent lamp is decreased.

In FIG. 4, the first external protruded portion 312 corresponds to a portion of discharge spaces 260 on a lower portion of the flat fluorescent lamp 200. That is, a location of the first external protruded portion 312 is determined based on a temperature distribution between the discharge spaces 260 on the lower portion of the flat fluorescent lamp 200. In particular, a distance between the first external protruded portion 312 and a lower surface of the flat fluorescent lamp 200 is increased closer to the lower portion of the flat fluorescent lamp 200. Advantageously, a temperature uniformity of the flat fluorescent lamp 200 is increased.

In FIG. 4, the distance between the first external protruded portion 312 and a lower surface of the flat fluorescent lamp 200 is linearly increased, as a distance from a lower portion of the flat fluorescent lamp 200 is decreased. That is, the first external protruded portion 312 may have a substantially inclined linear cross-section. In alternative exemplary embodiments, the first external protruded portion 312 may have a curvilinear cross-section, a polygonal cross-section, etc., based on the temperature distribution of the discharge spaces 260 on the lower portion of the flat fluorescent lamp 200.

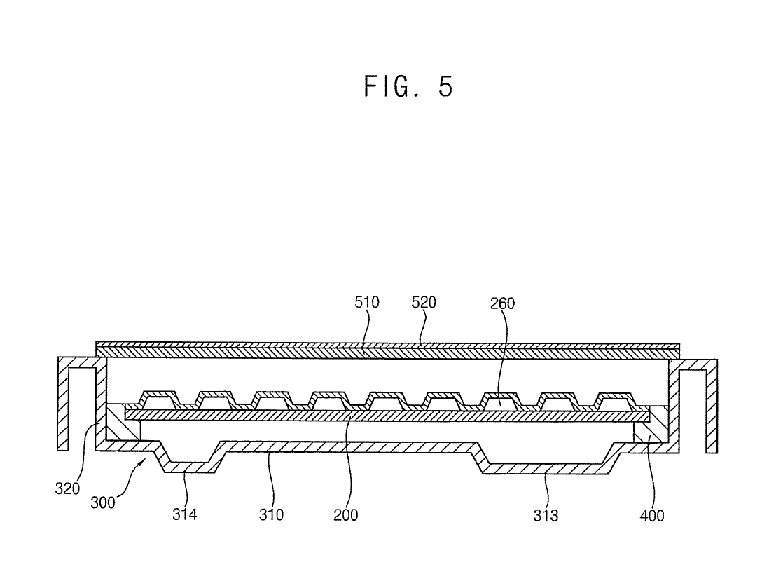

FIG. 5 is a cross-sectional view illustrating another exemplary embodiment of a bottom chassis in accordance with the present invention. A backlight assembly of FIG. 5 is the same as in FIGS. 1 and 2 except the bottom chassis. Thus, the same reference numerals will be used to refer to the same or like parts as those described in FIGS. 1 and 2 and any further explanation concerning the above elements will be omitted.

Referring to FIG. 5, the bottom chassis 300 includes a first external protruded portion 313 and a second external protruded portion 314. The first external protruded portion 313 corresponds to a lower portion of the flat fluorescent lamp 200 and the second external protruded portion 314 corresponds to an upper portion of the flat fluorescent lamp 200.

The first external protruded portion 313 is protruded toward an exterior of the bottom chassis 300 to increase a temperature of the lower portion of the flat fluorescent lamp 200. In one exemplary embodiment, the first external protruded portion 313 corresponds to five discharge spaces 260 disposed proximate to the lower portion of the flat fluorescent lamp 200.

The second external protruded portion 314 is protruded toward an exterior of the bottom chassis 300 to increase a temperature of the upper portion of the flat fluorescent lamp 200. In FIG. 3, one uppermost discharge space has a lower temperature than the discharge spaces on the central portion of the flat fluorescent lamp 200. Thus, in FIG. 5, the second external protruded portion 314 corresponds to the uppermost discharge spaces 260 disposed proximate to the upper portion of the flat fluorescent lamp 200.

The bottom surface of the first and second external protruded portions 313 and 314 is substantially parallel to the bottom surface of the flat fluorescent lamp 200. Side surfaces of the first and second external protruded portions 313 and 314 are inclined down from the flat fluorescent lamp 200 towards the bottom surfaces of the first and second external protruded portions 313 and 314. A distance between the bottom surfaces of the first and second external protruded portions 313 and 314 is substantially uniform from the bottom surface of the flat fluorescent lamp 200. In alternative exemplary embodiments, each of the bottom surfaces of the first and second external protruded portions may both be substantially planar, may both be inclined or one of the bottom surfaces may be planar while the other is inclined relative to the bottom surface of the flat fluorescent lamp 200.

The bottom chassis 300 includes the first and second external protruded portions 313 and 314 to increase the temperature uniformity in the discharge spaces 260 of the flat fluorescent lamp 200.

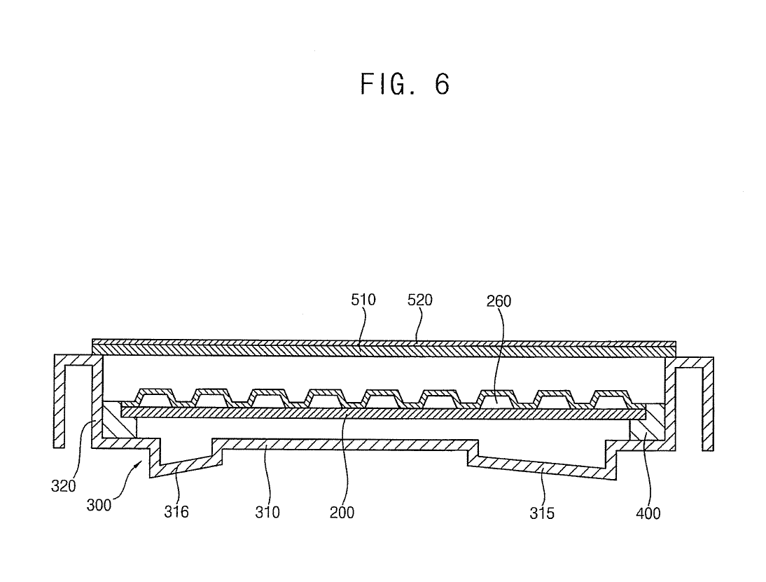

FIG. 6 is a cross-sectional view illustrating another exemplary embodiment of a bottom chassis having first and second external protruded portions in accordance with the present invention. A backlight assembly of FIG. 6 is the same as in FIG. 5 except a bottom chassis. Thus, the same reference numerals will be used to refer to the same or like parts as those described in FIG. 5 and any further explanation concerning the above elements will be omitted.

Referring to FIG. 6, a distance between the first external protruded portion 315 and a lower surface of a flat fluorescent lamp 200 is increased as a distance from a lower portion of the flat fluorescent lamp 200 is decreased. In addition, a distance between the second external protruded portion 316 and the lower surface of the flat fluorescent lamp 200 is increased as a distance from an upper portion of the flat fluorescent lamp 200 is decreased. Each of the first and second external protruded portions 315 and 316 has an inclined linear cross-section. In alternative exemplary embodiments, each of the first and second external protruded portions 315 and 316 may have various cross-sections based on a temperature distribution of the flat fluorescent lamp 200. Lengths of the first and second external protruded portions in a direction substantially parallel to the bottom surface of the flat fluorescent lamp 200 and/or depths in a direction substantially perpendicular to the bottom surface of the flat fluorescent lamp 200 may be determined proportionately with the location of the lower temperature discharge spaces 260 and/or the number of lower temperature discharge spaces 260 of the flat fluorescent lamp 200.

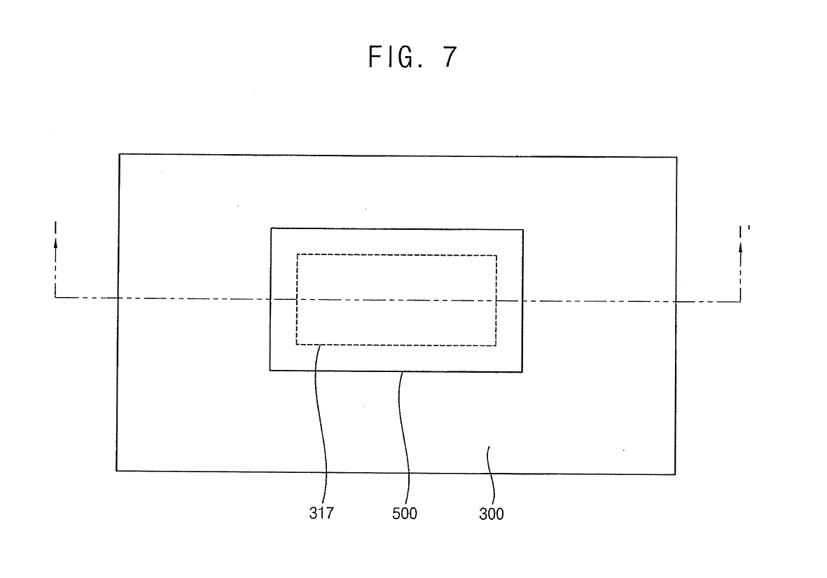

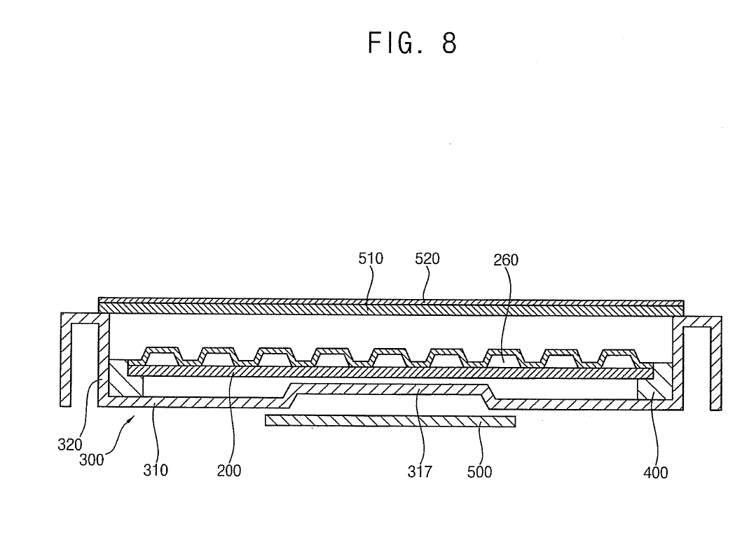

FIG. 7 is a plan view illustrating an exemplary embodiment of a rear surface of a bottom chassis in accordance with the present invention. FIG. 8 is a cross-sectional view taken along line I-I′ shown in FIG. 7. A backlight assembly of FIGS. 7 and 8 is the same as in FIGS. 1 and 2 except a bottom chassis. Thus, the same reference numerals will be used to refer to the same or like parts as those described in FIGS. 1 and 2 and any further explanation concerning the above elements will be omitted.

Referring to FIGS. 7 and 8, a power supply printed circuit board 500 is on a central portion of a rear surface of the bottom chassis 300.

The bottom chassis 300 includes an internal protruded portion 317 protruded toward the flat fluorescent lamp 200 such that a distance between the flat fluorescent lamp 200 and the bottom chassis 300 is decreased. That is, the internal protruded portion 317 is protruded toward an interior of the bottom chassis 300. In FIGS. 7 and 8, the internal protruded portion 317 corresponds in relative dimension and location to the power supply printed circuit board 500 that is on the central portion of the rear surface of the bottom chassis 300.

In operation of the backlight assembly, heat is generated from the power supply printed circuit board 500. When the bottom chassis 300 does not include the internal protruded portion 317, the heat generated from the power supply printed circuit board 500 may increase a temperature of a central portion of the flat fluorescent lamp 200, thereby accelerating drifting of mercury (Hg) in the discharge spaces 260.

In FIG. 8, the bottom chassis 300 includes the internal protruded portion 317 on the central portion so that the temperature of the central portion of the flat fluorescent lamp 200 is decreased, thereby increasing the temperature uniformity of the flat fluorescent lamp 200.

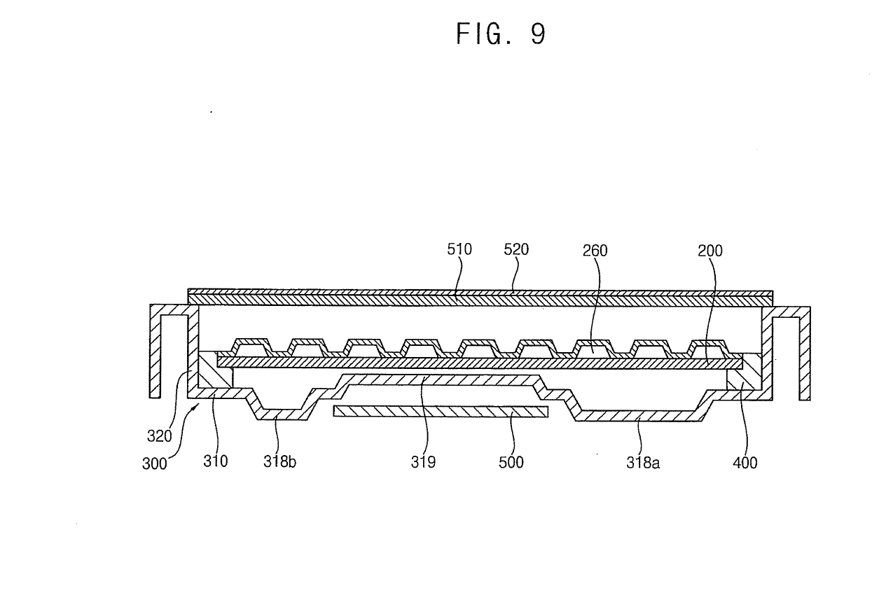

FIG. 9 is a cross-sectional view illustrating another exemplary embodiment of a bottom chassis in accordance with the present invention. A backlight assembly of FIG. 9 is the same as in FIGS. 7 and 8 except a bottom chassis. Thus, the same reference numerals will be used to refer to the same or like parts as those described in FIGS. 7 and 8 and any further explanation concerning the above elements will be omitted.

Referring to FIG. 9, the bottom chassis 300 includes an external protruded portion 318 and an internal protruded portion 319. The external protruded portion 318 is protruded toward an exterior of the backlight assembly 100 such that a distance between the flat fluorescent lamp 200 and an upper portion of the bottom chassis 300 and a distance between the flat fluorescent lamp 200 and a lower portion of the bottom chassis 300 are increased when the backlight assembly 100 is aligned in a substantially vertical direction, thereby increasing a temperature of the upper and lower portions of the bottom chassis 300. The internal protruded portion 319 is protruded toward the flat fluorescent lamp 200 such that a distance between the flat fluorescent lamp 200 and a central portion of the bottom chassis 300 is decreased, thereby decreasing a temperature of the central portion of the bottom chassis 300.

The internal protruded portion 319 corresponds substantially to the central portion of the flat fluorescent lamp 200. In the illustrated embodiment of FIG. 9, the internal protruded portion 319 corresponds substantially in location and size to the power supply printed circuit board 500.

The external protruded portion 318 includes a first external protrusion 318a and a second external protrusion 318b. The first external protrusion 318a is disposed on the lower portion of the flat fluorescent lamp 200. The second external protrusion 318b is on the upper portion of the flat fluorescent lamp 200. In one exemplary embodiment, the first external protrusion 318a corresponds to a specific number of discharge spaces 260, such as five discharge spaces 260 on the lower portion of the flat fluorescent lamp 200. The second external protrusion 318b corresponds to uppermost discharge space 260 on the upper portion of the flat fluorescent lamp 200.

In the illustrated exemplary embodiment, the bottom chassis 300 includes the external protruded portion 318 and the internal protruded portion 319 arranged based on a temperature distribution of the flat fluorescent lamp 200 to increase temperature uniformity of the flat fluorescent lamp 200. Advantageously, drifting of mercury that may be caused by temperature difference in the flat fluorescent lamp 200 is reduced or effectively prevented to remove a shadow on a display panel, thereby improving image display quality.

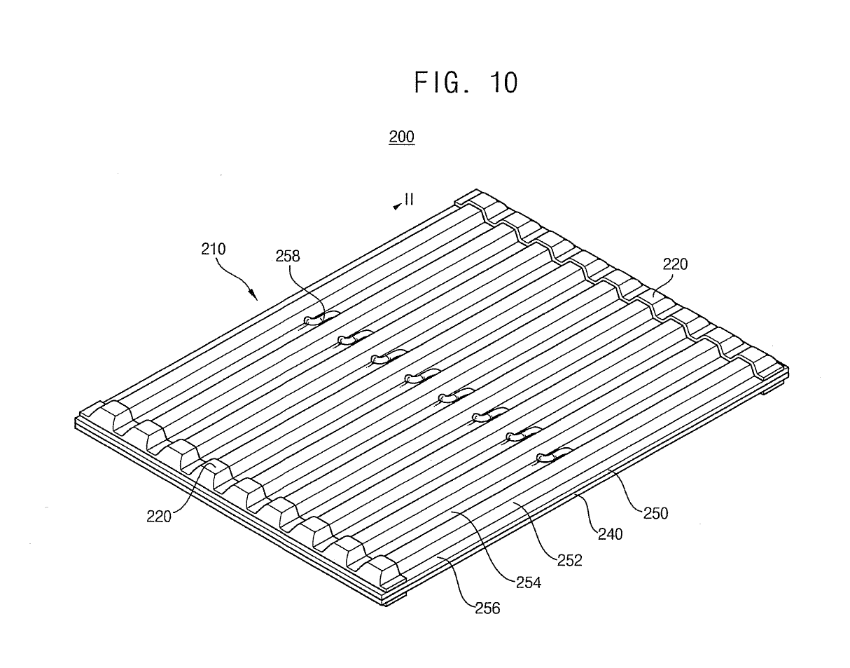

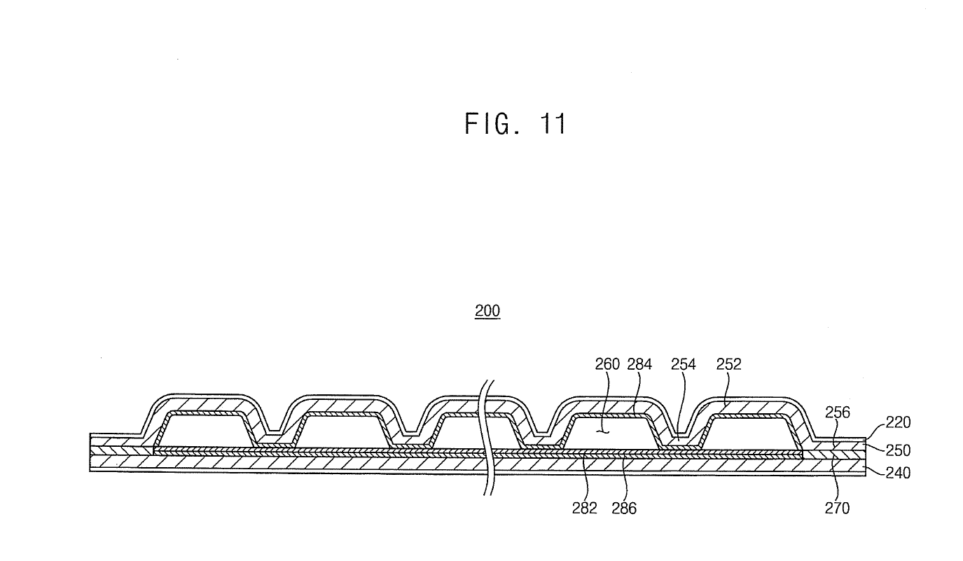

FIG. 10 is a perspective view illustrating an exemplary embodiment of a flat fluorescent lamp shown in FIG. 1. FIG. 11 is a cross-sectional view taken along line II-II′ shown in FIG. 10.

Referring to FIGS. 10 and 11, the flat fluorescent lamp 200 includes a lamp body 210 and an external electrode 220. The external electrode 220 is formed on the lamp body 210. In alternative exemplary embodiments, the flat fluorescent lamp 200 may further include a plurality of external electrodes 220.

The lamp body 210 includes a first substrate 240 and a second substrate 250. The second substrate 250 is combined with the first substrate 240 to form a plurality of discharge spaces 260.

The first substrate 240 may have a substantially quadrangular plate shape. In one exemplary embodiment, the first substrate 240 is a glass substrate. The first substrate 240 may include a ultraviolet blocking material that blocks ultraviolet light generated in the discharge spaces 260.

The second substrate 250 is formed to define the discharge spaces 260. The second substrate 250 may include a transparent material that transmits visible light generated based on the ultraviolet light from the discharge spaces 260. In one exemplary embodiment, the second substrate 250 includes a glass substrate. The second substrate 250 may include a ultraviolet blocking material that blocks the ultraviolet light generated in the discharge spaces 260.

The second substrate 250 may be formed through various methods. In one exemplary embodiment, a glass substrate having a substantially same plate shape as the first substrate 240 is heated and molded to form the second substrate 250. The glass substrate having the plate shape may be heated and pressed to form the second substrate 250. In an alternative exemplary embodiment, the glass substrate having the plate shape may be heated and pressed by air through a blow molding method to form the second substrate 250.

The second substrate 250 includes a plurality of discharge portions 252, a plurality of non-discharge portions 254 and a sealing portion 256 to form the discharge spaces 260. The discharge portions 252 are spaced apart from the first substrate 240 to define the discharge spaces 260. The non-discharge portions 254 are disposed between the discharge portions 252 and make contact with the first substrate 240 to divide an internal space of the flat fluorescent lamp 200 into the discharge spaces 260. The sealing portion 256 is disposed on a peripheral portion of the second substrate 250. The first substrate 240 is combined with the second substrate 250 through the sealing portion 256.

A connecting passage 258 may be formed on the second substrate 250 between adjacent discharge spaces 260 to connect the adjacent discharge spaces 260. In the illustrated embodiment of FIG. 10, at least one connecting passage 258 is formed on each of the non-discharge portions 254. Air in the discharge spaces 260 may be exhausted through the connecting passage 258 and/or a discharge gas may be injected into the discharge spaces 260 through the connecting passage 258. The connecting passage 258 may be simultaneously formed with the discharge portions 252, the non-discharge portions 254 and/or the sealing portion 256. The connecting passage 258 may have various shapes. In one exemplary embodiment, the connecting passage 258 may have substantially an S-shape to increase a path length of the discharge gas, thereby decreasing a channeling or the space required for the connecting passage 258 between the adjacent discharge spaces 260.

Referring to FIG. 11, the first substrate 240 is combined with the second substrate 250 through an adhesive member 270. In one exemplary embodiment, the adhesive member 270 includes frit that is a mixture of glass and metal. The frit has a lower melting temperature than pure glass. The adhesive member 270 is interposed between the sealing portion 256 of the second substrate 250 and the first substrate 240 to combine the first substrate 240 with the second substrate 250. In an exemplary embodiment, the adhesive member 270 that is interposed between the first and second substrates 240 and 250 is melted by an externally provided heat so that the first substrate 240 is combined with the second substrate 250.

The non-discharge portions 254 of the second substrate 250 are combined with the first substrate 240 by a pressure difference between inside and outside of the lamp body 210. In an exemplary embodiment, the first substrate 240 is combined with the second substrate 250 and the air between the first and second substrates 240 and 250 is discharged so that the discharge spaces 260 are evacuated. The discharge gas is injected into the evacuated discharge spaces 260. In one exemplary embodiment, the discharge gas may include, but is not limited to, mercury (Hg), neon (Ne), Argon (Ar), etc. In the illustrated embodiment of FIGS. 10 and 11, a pressure of the discharge gas in the discharge spaces 260 may be about 50 Torr to 70 Torr and an atmospheric pressure of the outside of the lamp body 210 is about 760 Torr, thereby forming the pressure difference. Due to the pressure difference, the non-discharge portions 254 are combined with the first substrate 240.

The flat fluorescent lamp 200 may further include a first fluorescent layer 282 and a second fluorescent layer 284. The first fluorescent layer 282 is disposed on a surface of the first substrate 240 facing the second substrate 250. The second fluorescent layer 284 is disposed on a surface of the second substrate 250 facing the first substrate 240. When the ultraviolet light generated by the plasma discharge is irradiated onto the first and second fluorescent layers 282 and 284, excitons are generated in the first and second fluorescent layers 282 and 284. When an energy level of the excitons is decreased, the first and second fluorescent layers 282 and 284 emit the visible light.

The flat fluorescent lamp 200 may further include a reflecting layer 286 interposed between the first substrate 240 and the first fluorescent layer 282. A portion of the visible light is reflected from the reflecting layer 286 toward the second substrate 250 to prevent a light leakage of the visible light through the first substrate 240.

The flat fluorescent lamp 200 may further include a protecting layer (not shown) between the first substrate 240 and the reflecting layer 286 and between the second substrate 250 and the second fluorescent layer 284. The protecting layer (not shown) prevents a chemical reaction between the mercury (Hg) in the discharge gas and the first or second substrate 240 or 250 to prevent a loss of the mercury and a black spot on the inner surface of the lamp body 210.

The external electrode 220 is disposed on at least one of the first and second substrates 240 and 250. In FIGS. 10 and 11, the external electrode 220 is disposed on end portions of the lamp body 210 and is aligned in a direction substantially in perpendicular to a longitudinal direction of the discharge spaces 260. The external electrode 220 crosses the discharge spaces 260 in a substantially transverse direction to the discharge spaces 260 to apply a discharge voltage to the discharge gas in the discharge spaces 260.

When the external electrode 220 is formed on the first substrate 240 and the second substrates 250, a portion of the external electrode 220 on the first substrate 240 may be electrically connected to a portion of the external electrode 220 on the second substrate 250 through a conductive clip (not shown).

The external electrode 220 may include a conductive material so that the discharge voltage from the power supply printed circuit board is applied to the lamp body 210 through the external electrode 220. In one exemplary embodiment, the external electrode 220 may include a silver paste that is a mixture of silver (Ag) and silicon oxide (SiO2). In an alternative exemplary embodiment, the external electrode 220 may include a metal, a metal mixture, etc. The external electrode 220 may be formed through any of a number of method suitable for the purpose described herein, such as a spray method, a spin coating method, a dipping method, etc. In an alternative embodiment, the external electrode 220 may be a metal socket.

In FIGS. 10 and 11, the second substrate 250 of the lamp body 210 is formed or molded to form the discharge spaces 260. In an alternative exemplary embodiment, the second substrate of the lamp body may have a substantially plate shape and a plurality of partition walls may be interposed between the first and second substrates to form the discharge spaces.

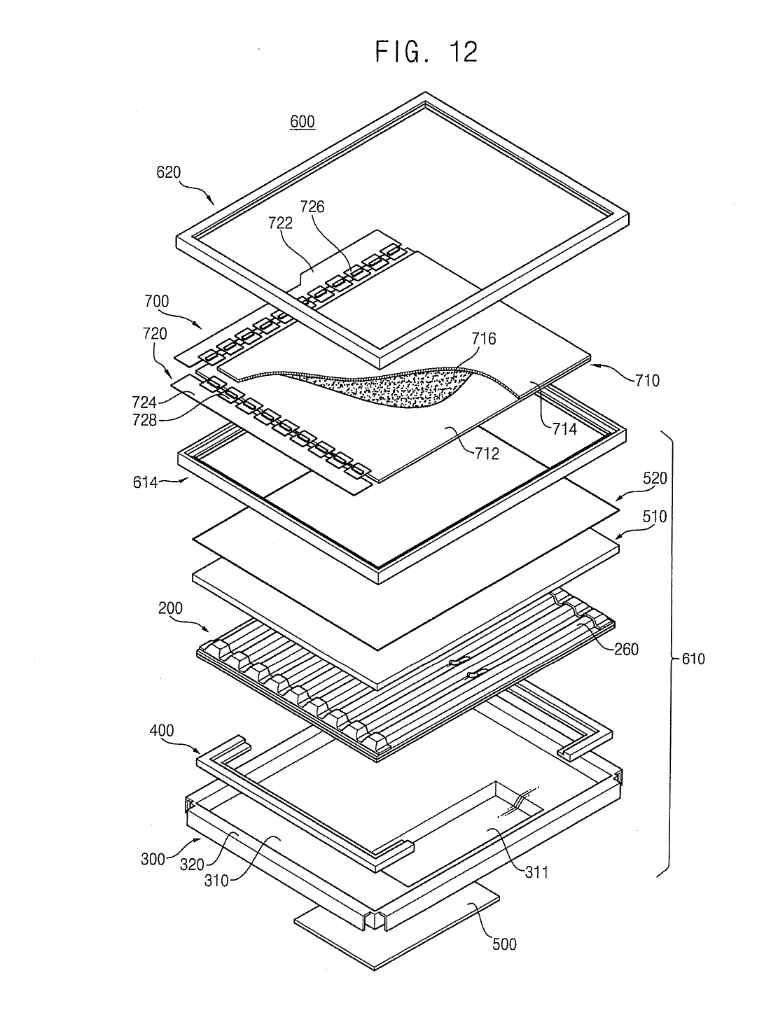

FIG. 12 is an exploded perspective view illustrating an exemplary embodiment of a display device in accordance with the present invention.

Referring to FIG. 12, the display device 600 includes a backlight assembly 610 and a display unit 700. The backlight assembly 610 generates light. The display unit 700 displays images based on the light generated from the backlight assembly 610.

The backlight assembly of FIG. 12 is substantially the same as in FIGS. 1 to 11. Thus, the same reference numerals will be used to refer to the same or like parts as those described in FIGS. 1 to 11 and any further explanation concerning the above elements will be omitted.

The backlight assembly 610 may further include a mold frame 614 interposed between optical sheets 520 and the display unit 700. The mold frame 614 fixes a peripheral portion of a diffusion plate 510 and an optical sheet 520 to a buffer member 400 and supports a peripheral portion of a liquid crystal display (LCD) panel 710. The mold frame 614 may have an integrally formed frame structure. In an alternative embodiment, multiple pieces, such as two or four pieces, may be assembled to form the mold frame 614.

The display unit 700 includes the LCD panel 710 and a driving circuit part 720. The LCD panel 710 displays images based on the light generated from the backlight assembly 610. The driving circuit part 720 generates signals to drive the LCD panel 710.

The LCD panel 710 includes a first display substrate 712, a second display substrate 714 and a liquid crystal layer 716. The second display substrate 714 is combined with the first display substrate 712. The liquid crystal layer 716 is interposed between the first and second display substrates 712 and 714.

The first display substrate 712 includes a plurality of thin film transistors (TFT) (not shown) that are switching elements. The TFTs are arranged substantially in a matrix shape. A source electrode of each of the TFTs is electrically connected to a data line. A gate electrode of the TFT is electrically connected to a gate line. A drain electrode of the TFT is electrically connected to a pixel electrode that includes a transparent conductive material.

The second display substrate 714 includes a plurality of color filters (not shown) having a thin film shape to display color images. The second display substrate 714 may further include a common electrode having a transparent conductive material.

When a voltage is applied to the gate electrode of the TFT, the TFT is turned on so that an electric field is formed between the pixel electrode and the common electrode. Liquid crystals of the liquid crystal layer 716 vary their arrangement in response to the electric field applied to the liquid crystal layer 716 and a light transmittance of the liquid crystal layer 716 is changed to display the images having a predetermined gray-scale.

The driving circuit part 720 includes a data printed circuit board 722, a gate printed circuit board 724, a data driving circuit film 726 and a gate driving circuit film 728. The data printed circuit board 722 applies data driving signals to the LCD panel 710. The gate printed circuit board 724 applies gate driving signals to the LCD panel 710. The data printed circuit board 722 is electrically connected to the LCD panel 710 through the data driving circuit film 726. The gate printed circuit board 724 is electrically connected to the LCD panel 710 through the gate driving circuit film 728. In exemplary embodiments, each of the data driving circuit film 726 and the gate driving circuit film 728 may include a tape carrier package (TCP) or a chip on film (COF). In alternative exemplary embodiments, an additional signal line may be formed on the LCD panel 710 and the gate driving circuit film 728 so that the gate printed circuit board 724 may be omitted.

The display device 600 may further include a top chassis 620 that fixes the display unit 700 to the backlight assembly 610. The top chassis 620 is combined with the bottom chassis 300 to fix the peripheral portion of the LCD panel 710 to the backlight assembly 610. The data printed circuit board 722 is bent toward a side surface or a rear surface of the bottom chassis 300 by the data driving circuit film 726. The top chassis 620 may include a strong metal that is resistant to a deformation.

In the illustrated exemplary embodiments, the external protruded portion or the internal protruded portion is formed on the bottom chassis to control and vary the distance between the bottom chassis and the flat fluorescent lamp. Consequently, the temperature uniformity of the flat fluorescent lamp is increased.

When the temperature uniformity of the flat fluorescent lamp is increased, the drifting of the mercury in the flat fluorescent lamp is decreased. Advantageously, the shadow on the backlight assembly is decreased, and the image display quality is improved.

This invention has been described with reference to the example embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a flat fluorescent lamp including:
a first substrate;
a second substrate combined with the first substrate and forming a plurality of discharge spaces; and
an external electrode crossing the discharge spaces; and
a bottom chassis receiving the flat fluorescent lamp and including a protruded portion spaced apart from the flat fluorescent lamp by a distance that is different from a distance between a remaining portion of the bottom chassis and the flat fluorescent lamp.

2. The backlight assembly of claim 1, wherein the protruded portion comprises a first external protrusion protruded toward an exterior of the bottom chassis and a distance between the first external protrusion and the flat fluorescent lamp is greater than the distance between the remaining portion of the bottom chassis and the flat fluorescent lamp.

3. The backlight assembly of claim 2, wherein the first external protrusion corresponds to a lower portion of the flat fluorescent lamp when the flat fluorescent lamp is aligned substantially vertical.

4. The backlight assembly of claim 3, wherein the first external protrusion corresponds to five discharge spaces corresponding to the lower portion of the flat fluorescent lamp.

5. The backlight assembly of claim 3, wherein the distance between the first external protrusion and the flat fluorescent lamp is increased as a distance from a lower portion of the flat fluorescent lamp is decreased.

6. The backlight assembly of claim 3, wherein the protruded portion further comprises a second external protrusion corresponding to an upper portion of the flat fluorescent lamp.

7. The backlight assembly of claim 6, wherein the second external protrusion corresponds to uppermost discharge spaces on the upper portion of the flat fluorescent lamp.

8. The backlight assembly of claim 6, wherein the distance between the second external protrusion and the flat fluorescent lamp is increased, as a distance from an upper portion of the flat fluorescent lamp is decreased.

9. The backlight assembly of claim 1, wherein the protruded portion comprises an internal protruded portion protruded toward an interior of the bottom chassis and a distance between the internal protrusion and the flat fluorescent lamp is smaller than the distance between the remaining portion of the bottom chassis and the flat fluorescent lamp.

10. The backlight assembly of claim 9, wherein the internal protruded portion corresponds to a central portion of the flat fluorescent lamp.

11. The backlight assembly of claim 10, further comprising a power supply printed circuit board disposed at a rear surface of the bottom chassis, wherein the internal protruded portion corresponds to the power supply printed circuit board.

12. The backlight assembly of claim 1, wherein the protruded portion comprises:
an external protruded portion protruded toward an exterior of the bottom chassis and a distance between the external protruded portion and the flat fluorescent lamp is greater than the distance between the remaining portion of the bottom chassis and the flat fluorescent lamp; and
an internal protruded portion protruded toward an interior of the bottom chassis and a distance between the internal protruded portion and the flat fluorescent lamp is smaller than the distance between the remaining portion of the bottom chassis and the flat fluorescent lamp.

13. The backlight assembly of claim 12, further comprising a power supply printed circuit board disposed at a rear surface of the bottom chassis, wherein the internal protruded portion corresponds to the power supply printed circuit board.

14. The backlight assembly of claim 12, wherein the external protruded portion comprises a first external protrusion corresponding to a lower portion of the flat fluorescent lamp when the flat fluorescent lamp is aligned substantially vertical.

15. The backlight assembly of claim 14, wherein the external protruded portion comprises a second external protrusion corresponding to an upper portion of the flat fluorescent lamp.

16. The backlight assembly of claim 1, wherein the second substrate comprises:
a plurality of discharge portions spaced apart from the first substrate and forming the discharge spaces;
a plurality of non-discharge portions making contact with the first substrate between adjacent discharge portions; and
a sealing portion on a peripheral portion surrounding the discharge portions and the non-discharge portions, the first substrate being combined with the second substrate through the sealing portion.

17. The backlight assembly of claim 1, further comprising a buffer member interposed between the flat fluorescent lamp and the bottom chassis so that the flat fluorescent lamp is spaced apart from the bottom chassis.

18. A display device comprising:
a backlight assembly generating light, the backlight assembly including:
a flat fluorescent lamp including a first substrate, a second substrate combined with the first substrate and forming a plurality of discharge spaces and an external electrode crossing the discharge spaces; and
a bottom chassis receiving the flat fluorescent lamp and including an external protruded portion spaced apart from the flat fluorescent lamp by a distance that is greater than a distance between a remaining portion of the bottom chassis and the flat fluorescent lamp; and
a display unit displaying images based on the light generated from the backlight assembly.

19. The display device of claim 18, wherein the external protruded portion comprises a first external protrusion corresponding to a lower portion of the flat fluorescent lamp when the flat fluorescent lamp is aligned substantially vertical.

20. The display device of claim 19, wherein the external protruded portion comprises a second external protrusion corresponding to an upper portion of the flat fluorescent lamp.

21. The display device of claim 18, wherein the bottom chassis comprises an internal protruded portion protruded toward an interior of the bottom chassis and a distance between the internal protruded portion and the flat fluorescent lamp is smaller than the distance between the remaining portion of the bottom chassis and the flat fluorescent lamp.

22. The display device of claim 21, further comprising a power supply printed circuit board disposed at a rear surface of the bottom chassis, wherein the internal protruded portion corresponds to the power supply printed circuit board.
